(19) United States
(12) Patent Application Publication
(10) Pub. No.: US 2014/0210582 A1
(43) Pub. Date: Jul. 31, 2014

(54) RARE-EARTH PERMANENT MAGNET AND METHOD FOR MANUFACTURING RARE-EARTH PERMANENT MAGNET

(71) Applicant: NITTO DENKO CORPORATION, Ibaraki-shi, Osaka (JP)

(72) Inventors: Izumi Ozeki, Ibaraki-shi (JP); Katsuya Kume, Ibaraki-shi (JP); Toshiaki Okuno, Ibaraki-shi (JP); Tomohiro Omure, Ibaraki-shi (JP); Takashi Ozaki, Ibaraki-shi (JP); Keisuke Taihaku, Ibaraki-shi (JP); Takashi Yamamoto, Ibaraki-shi (JP)

(73) Assignee: NITTO DENKO CORPORATION, Ibaraki-shi, Osaka (JP)

(21) Appl. No.: 14/342,095

(22) PCT Filed: Oct. 1, 2012
(86) PCT No.: PCT/JP2012/075366

§ 371 Date: Feb. 28, 2014

(30) Foreign Application Priority Data
Oct. 14, 2011 (JP) 2011-227073

(51) Int. Cl. H01F 1/01; H01F 41/02

(52) U.S. Cl. CPC H01F 1/015; H01F 41/0266
USPC 335/302; 419/33

(57) ABSTRACT

There are provided a rare-earth permanent magnet based on Nd—Fe—B, capable of improving coercive force through reducing a residual nitrogen concentration after sintering to be 800 ppm or lower, and a manufacturing method of the rare-earth permanent magnet. The rare-earth permanent magnet based on Nd—Fe—B is obtained through milling a magnet material in an atmosphere of a noble gas by dry milling, and thereafter, compacting the milled magnet material into a formed body in an atmosphere of a noble gas. The formed body is then sintered at 800 through 1180 degrees Celsius so as to obtain a permanent magnet 1 whose nitrogen concentration is 800 ppm or lower, or more preferably 300 ppm or lower.

### TECHNICAL FIELD

The present invention relates to a rare-earth permanent magnet and a manufacturing method of the rare-earth permanent magnet.

### BACKGROUND ART

In recent years, a decrease in size and weight, an increase in power output and an increase in efficiency have been demanded in a permanent magnet motor used in a hybrid car, a hard disk drive, or the like. A further improvement in magnetic performance is required of a permanent magnet to be buried in the permanent magnet motor, for the purpose of realizing such a decrease in size and weight, an increase in power output and an increase in efficiency in the permanent magnet motor mentioned above. Meanwhile, as permanent magnet, there have been known ferrite magnets, Sm—Co-based magnets, Nd—Fe—B-based magnets, Sm₂Fe₁₇Nₓ-based magnets or the like. As permanent magnet for permanent magnet motor, Nd—Fe—B-based magnets are typically used among them due to their remarkably high residual magnetic flux density (refer to, for instance, Japanese Patent No. 3298219).

As method for manufacturing a permanent magnet, a powder sintering process is generally used. In this powder sintering process, raw material is coarsely milled first, and furthermore, is finely milled into magnet powder by a jet mill (dry-milling) method or a wet bead mill (wet-milling) method. Thereafter, the magnet powder is put in a mold and pressed to form in a desired shape with magnetic field applied from outside. Then, the magnet powder formed and solidified in the desired shape is sintered at a predetermined temperature (for instance, at a temperature between 800 and 1150 degrees Celsius for the case of Nd—Fe—B-based magnet) for completion.

### PRIOR ART DOCUMENT

### Patent Document

Patent document 1: Japanese Registered Patent Publication No. 3298219 (pages 4 and 5)

### DISCLOSURE OF THE INVENTION

### Problem to be Solved by the Invention

As to the Nd—Fe—B-based magnet to be employed in a permanent magnet motor, efforts have been made to improve the coercive force in order to increase power output of the motor. Conventional Nd—Fe—B-based magnets are, however, incapable of sufficiently improving the coercive force.

The invention has been made in order to solve the above-mentioned conventional problems, and an object of the invention is to provide a rare-earth permanent magnet capable of improving the coercive force through reducing a concentration of nitrogen remaining after sintering equal to or lower than 800 ppm in a Nd—Fe—B-based rare-earth permanent magnet and a manufacturing method of the rare-earth permanent magnet.

### Means for Solving the Problem

To achieve the above object, the present invention provides a rare-earth permanent magnet based on Nd—Fe—B, wherein a residual nitrogen concentration after sintering is 800 ppm or lower.

The above-described rare-earth permanent magnet of the present invention is manufactured through steps of milling magnet material in an atmosphere of a noble gas to obtain magnet powder; forming the magnet powder into a formed body in an atmosphere of a noble gas; and sintering the formed body. In the above-described rare-earth permanent magnet of the present invention, before the step of sintering the formed body, the formed body is calcined in a hydrogen atmosphere at a pressure equal to or higher than normal atmospheric pressure.

In the above-described rare-earth permanent magnet of the present invention, before the step of forming the magnet powder into a formed body, the magnet powder is calcined in a hydrogen atmosphere at a pressure equal to or higher than normal atmospheric pressure.

In the above-described rare-earth permanent magnet of the present invention, in the step of forming the magnet powder into a formed body, the magnet powder is mixed with a binder resin to produce a mixture and the mixture is formed into a sheet like shape to obtain a green sheet as the formed body; the steps of manufacturing further include a step of decomposing and removing the binder resin from the green sheet by holding the green sheet for a predetermined length of time at decomposition temperature of the binder resin in a non-oxidizing atmosphere; and in the step of sintering the formed body, the green sheet after removing the binder resin is sintered through raising temperature up to sintering temperature.

In the above-described rare-earth permanent magnet of the present invention, in the step of decomposing and removing the binder resin, the green sheet is held for a predetermined length of time in the non-oxidizing atmosphere at a pressure equal to or higher than normal atmospheric pressure.

To achieve the above object, the present invention provides a manufacturing method of a rare-earth permanent magnet comprising steps of milling magnet material in an atmosphere of a noble gas to obtain magnet powder; forming the magnet powder into a formed body in an atmosphere of a noble gas; and sintering the formed body.

In the above-described manufacturing method of a rare-earth permanent magnet of the present invention, before the step of sintering the formed body, the formed body is calcined in a hydrogen atmosphere at a pressure equal to or higher than normal atmospheric pressure.

In the above-described manufacturing method of a rare-earth permanent magnet of the present invention, before the step of forming the magnet powder into a formed body, the magnet powder is calcined in a hydrogen atmosphere at a pressure equal to or higher than normal atmospheric pressure.

In the above-described manufacturing method of a rare-earth permanent magnet of the present invention, in the step of forming the magnet powder into a formed body, the magnet powder is mixed with a binder resin to produce a mixture and the mixture is formed into a sheet like shape to obtain a green sheet as the formed body; the steps of the manufacturing method further include a step of decomposing and removing the binder resin from the green sheet by holding the green sheet for a predetermined length of time at decomposition temperature of the binder resin in a non-oxidizing atmosphere; and in the step of sintering the formed body, the green sheet after removing the binder resin is sintered through raising temperature up to sintering temperature.

In the above-described manufacturing method of a rare-earth permanent magnet of the present invention, in the step of decomposing and removing the binder resin, the green sheet is held for a predetermined length of time in the non-oxidizing atmosphere at a pressure equal to or higher than normal atmospheric pressure.

### Effect of the Invention

According to the rare-earth permanent magnet of the present invention, through reducing the residual nitrogen concentration after sintering to be 800 ppm or lower in the rare-earth permanent magnet based on Nd—Fe—B, the coercive force can be improved.

According to the rare-earth permanent magnet of the present invention, as both the step of milling magnet material and the step of forming the magnet powder into a formed body are carried out in an atmosphere of a noble gas such as helium or argon, the residual nitrogen concentration after sintering can be reduced to 800 ppm or lower. As a result, the amount of impurities being neodymium nitride (NdN) can be decreased, so that the coercive force of the rare-earth permanent magnet can be improved without wasting the Nd-rich phase.

According to the rare-earth permanent magnet of the present invention, a formed body of magnet powder is calcined in a hydrogen atmosphere at a pressure equal to or higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Furthermore, according to the rare-earth permanent magnet of the present invention, magnet powder is calcined in a hydrogen atmosphere at a pressure equal to or higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Further, since powdery magnet particles are calcined, thermal decomposition of the organic compound can be caused more easily in the entirety of the magnet particles in comparison with the case of calcining magnet particles already molded into a shape. In other words, carbon content in the calcined powder can be reduced more reliably.

According to the rare-earth permanent magnet of the present invention, the rare-earth permanent magnet is a sintered magnet made from a green sheet obtained by mixing magnet powder and a resin binder and forming the mixture into a sheet-like shape. Therefore, the thus sintered green sheet uniformly contracts and deformations such as warps and depressions do not occur to the sintered green sheet. Further, the sintered green sheet having uniformly contracted receives pressure uniformly, which eliminates adjustment process to be conventionally performed after sintering and simplifies the manufacturing process. Thereby, a rare-earth permanent magnet can be manufactured with dimensional accuracy. Further, even if such rare-earth permanent magnets are manufactured with thinner design, increase in the number of manufacturing processes can be avoided without lowering a material yield. Further, magnet powder to which a binder resin has been added is calcined for a predetermined length of time under a non-oxidizing atmosphere before sintering, whereby carbon content in the permanent magnet can be reduced previously. Consequently, previous reduction of carbon can prevent alpha iron from separating out in a main phase of the sintered magnet and the entirety of the magnet can be sintered densely. Thereby, decrease in the coercive force can be prevented.

Further, according to the rare-earth permanent magnet of the present invention, in the step of decomposing and removing the binder resin, the magnet particles are held for a predetermined length of time in a pressurized atmosphere at a pressure equal to or higher than normal atmospheric pressure. Thereby, carbon content in the magnet particles can be reduced more reliably.

Further, according to the manufacturing method of a rare-earth permanent magnet of the present invention, as both the step of milling magnet material and the step of forming the magnet powder into a formed body are carried out in an atmosphere of a noble gas such as helium or argon, the concentration of nitrogen remaining after sintering can be reduced to 800 ppm or lower. As a result, the amount of impurities being neodymium nitride (NdN) can be decreased, preventing wasteful consumption of Nd-rich phase, so that the coercive force of the rare-earth permanent magnet can be improved.

According to the manufacturing method of a rare-earth permanent magnet of the present invention, a formed body of magnet powder is calcined in a hydrogen atmosphere at a pressure equal to or higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Furthermore, according to the manufacturing method of a rare-earth permanent magnet of the present invention, magnet powder is calcined in a hydrogen atmosphere at a pressure equal to or higher than normal atmospheric pressure before sintering, so that the carbon content in the magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Further, since powdery magnet particles are calcined, thermal decomposition of the organic compound can be caused more easily in the entirety of the magnet particles in comparison with the case of calcining magnet particles already molded into a shape. In other words, carbon content in the calcined powder can be reduced more reliably.

According to the manufacturing method of a rare-earth permanent magnet of the present invention, the rare-earth permanent magnet is a sintered magnet made from a green sheet obtained by mixing magnet powder and a resin binder and forming the mixture into a sheet-like shape. Therefore, the thus sintered green sheet uniformly contracts and deformations such as warps and depressions do not occur to the sintered green sheet. Further, the sintered green sheet having uniformly contracted is pressed uniformly, which eliminates adjustment process to be conventionally performed after sintering and simplifies manufacturing process. Thereby, a rare-earth permanent magnet can be manufactured with dimensional accuracy. Further, even if such rare-earth permanent magnets are manufactured with thinner design, increase in the number of manufacturing processes can be avoided without lowering a material yield. Further, magnet powder to which a binder resin has been added is calcined for a predetermined length of time under a non-oxidizing atmosphere before sintering, whereby carbon content in the permanent magnet can be reduced previously. Consequently, previous reduction of carbon can prevent alpha iron from separating out in a main phase of the sintered magnet and the entirety of the magnet can be sintered densely. Thereby, decrease in the coercive force can be prevented.

Further, according to the manufacturing method of a rare-earth permanent magnet of the present invention, in the step of decomposing and removing the binder resin, the magnet particles are held for a predetermined length of time in a pressurized atmosphere at a pressure equal to or higher than normal atmospheric pressure. Thereby, carbon content in the magnet particles can be reduced more reliably.

### BRIEF DESCRIPTION OF THE DRAWINGS

FIG. 1 is an overall view of a permanent magnet directed to the invention.

FIG. 2 is an enlarged schematic view in vicinity of grain boundaries of the permanent magnet directed to the invention.

FIG. 3 is an explanatory diagram illustrating manufacturing processes of a permanent magnet according to a first manufacturing method of the invention.

FIG. 4 is an explanatory diagram illustrating manufacturing processes of a permanent magnet according to a second manufacturing method of the invention.

FIG. 5 is a diagram illustrating changes of oxygen content with and without a calcination process in hydrogen.

FIG. 6 is a table illustrating residual nitrogen concentrations and coercive forces in permanent magnets of an embodiment and a comparative example after sintering.

### BEST MODE FOR CARRYING OUT THE INVENTION

Specific embodiment of a rare-earth permanent magnet and a method for manufacturing the rare-earth permanent magnet according to the present invention will be described below in detail with reference to the drawings.

[Constitution of Permanent Magnet]

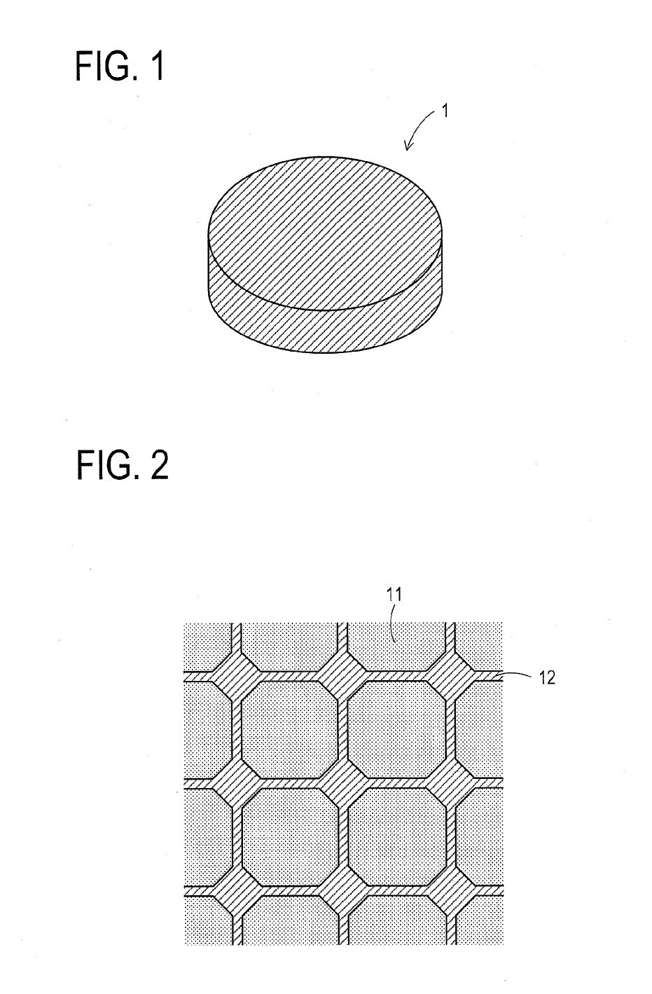

First, a constitution of a permanent magnet 1 will be described. FIG. 1 is an overall view of the permanent magnet directed to the present invention. Incidentally, the permanent magnet 1 depicted in FIG. 1 is formed into a cylindrical shape. However, the shape of the permanent magnet 1 may be changed in accordance with the shape of a cavity used for formation.

As the permanent magnet 1 according to the present invention, an Nd—Fe—B-based magnet may be used, for example. Further, as illustrated in FIG. 2, the permanent magnet 1 is an alloy in which a main phase 11 and an Nd-rich phase 12 coexist. The main phase 11 is a magnetic phase which contributes to the magnetization and the Nd-rich phase 12 is a low-melting-point and non-magnetic phase where rare earth elements are concentrated. FIG. 2 is an enlarged view of Nd magnet particles composing the permanent magnet 1.

Here, in the main phase 11, Nd₂Fe₁₄B intermetallic compound phase (Fe here may be partially replaced with Co), which is of a stoichiometric composition, accounts for high proportion in volume. Meanwhile, the Nd-rich phase 12 consists of an intermetallic compound phase having higher composition ratio of Nd than that of Nd₂Fe₁₄B (Fe here may be partially replaced with Co) of a stoichiometric composition, too (for example, Nd_{2.0-3.0}Fe₁₄B intermetallic compound phase). Further, the Nd-rich phase 12 may include a small amount of other elements such as Dy, Tb, Co, Cu, Al, Si or Ga for improving magnetic property.

Then, in the permanent magnet 1, the Nd-rich phase 12 has the following features. The Nd-rich phase 12:

(1) has a low melting point (approx. 600 degrees Celsius) and turns into a liquid phase at sintering, contributing to densification of the magnet, which means improvement in magnetization;
(2) can eliminate surface irregularity of grain boundaries, decreasing nucleation sites of reverse magnetic domain and enhancing coercive force; and
(3) can magnetically insulate the main phase, increasing the coercive force.

Poorly dispersed Nd-rich phase 12 in the sintered permanent magnet 1 potentially causes a partial sintering defect and degradation in the magnetic property; therefore it is important to have the Nd-rich phase 12 uniformly dispersed in the sintered permanent magnet 1.

An example of problems likely to rise when manufacturing the Nd—Fe—B-based magnet is formation of alpha iron in a sintered alloy. This may be caused as follows: when a permanent magnet is manufactured using a magnet raw material alloy whose contents are based on the stoichiometric composition, rare earth elements therein combine with oxygen during the manufacturing process so that the amount of rare earth elements becomes insufficient in comparison with the stoichiometric composition. Here, the alpha iron has deformability and remains unmilled in a milling device, and accordingly, the alpha iron not only deteriorates the efficiency in milling the alloy, but also adversely affects the grain size distribution and composition variation before and after milling. Further, if the alpha iron remains in the magnet even after sintering, the magnetic property of the magnet is degraded. However, in the present invention, hydrogen calcination before sintering enables the decrease in carbon contents included in magnet particles so that the above problems can be avoided.

Another example of problems likely to rise when manufacturing the Nd—Fe—B-based magnet is significantly high reactivity of Nd with carbon, which causes creation of carbide in case carbon-containing material remains even at a high-temperature stage in a sintering process. If carbide is created, there is a problem that gaps are formed between the main phase and the grain boundary phase (Nd-rich phase) of the magnet after sintering due to the created carbide, making it impossible to densely sinter the entirety of the magnet, and thus significantly deteriorating the magnetic properties thereof. However, in the present invention, the carbon content in magnet particles can be reduced in advance through performing a later-described calcination process in hydrogen before sintering, so that the above problems can be avoided.

It is thus desirable that the amount of all rare earth elements contained in the permanent magnet 1, including Nd, is within a range of 0.1 wt % through 10.0 wt % larger, or more preferably, 0.1 wt % through 5.0 wt % larger than the amount based upon the stoichiometric composition (26.7 wt %). Specifically, the contents of constituent elements are set to be Nd: 25 through 37 wt %, B: 0.8 through 2 wt %, Fe (electrolytic iron): 60 through 75 wt %, respectively. By setting the contents of rare earth elements in the permanent magnet within the above range, it becomes possible to obtain the sintered permanent magnet 1 in which the Nd-rich phase 12 is uniformly dispersed. Further, even if the rare earth elements are combined with oxygen during the manufacturing process, the formation of alpha iron in the sintered permanent magnet 1 can be prevented, without shortage of the rare earth elements in comparison with the stoichiometric composition.

Incidentally, if the amount of rare earth elements contained in the permanent magnet 1 is lower than the above-described range, the Nd-rich phase 12 becomes difficult to be formed. Also, the formation of alpha iron cannot sufficiently be inhibited. Meanwhile, if the content of rare earth elements in the permanent magnet 1 is larger than the above-described range, the increase of the coercive force becomes slow and also the residual magnetic flux density is reduced. Therefore such a case is impractical.

Further, it is desirable to set the crystal grain diameter of the main phase 11 to be 0.1 μm through 5.0 μm. Incidentally, the structure of the main phase 11 and the Nd-rich phase 12 can be confirmed, for instance, through scanning electron microscopy (SEM), transmission electron microscopy (TEM) or three-dimensional atom probe technique.

Highly anisotropic Dy or Tb may be included in the Nd-rich phase 12, so that coercive force can be improved by Dy or Tb inhibiting formation of the reverse magnetic domain in the grain boundaries.

High-melting-point metal such as V, Mo, Zr, Ta, Ti, W or Nb may be included in the Nd-rich phase 12, so as to inhibit so-called grain growth in which the average diameter of Nd crystal grains increases at sintering the permanent magnet 1.

Cu, Al may be included in the Nd-rich phase 12, so as to uniformly disperse the Nd-rich phase 12 in the permanent magnet 1 after sintering, and the coercive force can be improved.

The concentration of nitrogen remaining in the permanent magnet 1 after sintering is preferably 800 ppm or lower, or more preferably 300 ppm or lower. Lowering the residual nitrogen concentration after sintering can help reduce the amount of impurities being neodymium nitride (NdN), can prevent wasting the Nd-rich phase and can improve the coercive force of the permanent magnet 1 as later described.

### [First Method for Manufacturing Permanent Magnet]

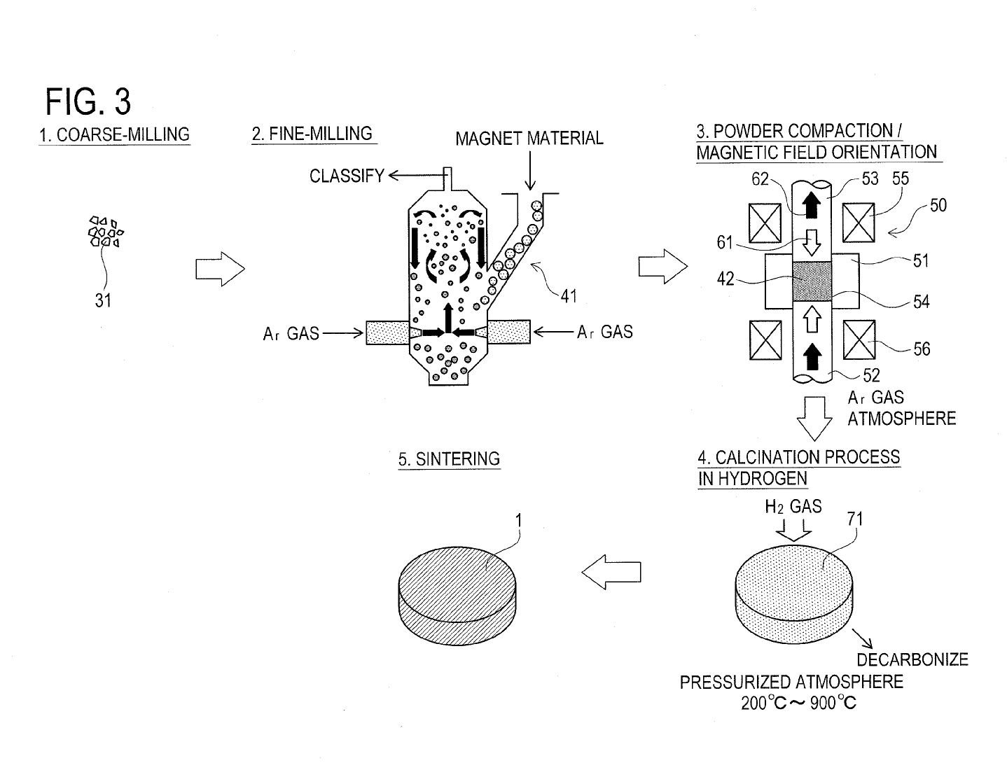

Next, the first method for manufacturing the permanent magnet 1 directed to the present invention will be described below with reference to FIG. 3. FIG. 3 is an explanatory view illustrating a manufacturing process in the first method for manufacturing the permanent magnet 1 directed to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is melted, formed into flakes using a strip-casting process, and then coarsely milled using a hydrogen pulverization method. Thus, coarsely-milled magnet powder 31 is obtained.

Next, the coarsely-milled magnet powder 31 is finely milled with a jet mill 41 to form fine powder of which the average particle diameter is smaller than a predetermined size (for instance, 0.1 μm through 5.0 μm) in: (a) an atmosphere composed of a noble gas such as argon (Ar) gas, helium (He) gas or the like having an oxygen content of substantially 0%; or (b) an atmosphere composed of a noble gas such as Ar gas, He gas or the like having an oxygen content of 0.0001 through 0.5%. Here, in the manufacturing method of permanent magnet 1 according to the present invention, the magnet material is milled under an atmosphere of inert gas such as Ar gas or He gas, specifically excluding nitrogen gas from among inert gases. Accordingly, there can be achieved the nitrogen concentration of 800 ppm or lower, or more preferably 300 ppm or lower, remaining after sintering, as later described. Here, the term “having an oxygen content of substantially 0%” is not limited to a case where the oxygen content is completely 0%, but may include a case where oxygen is contained in such an amount as to allow a slight formation of an oxide film on the surface of the fine powder.

However, the coarsely-milled magnet powder 31 may be finely milled with wet-milling using a bead mill, etc. Even in a case of employing wet-milling, the milling is performed under an atmosphere of a noble gas such as Ar gas or He gas. Furthermore, the solvent used for wet-milling is an organic solvent. However, there is no particular limitation on the types of solvent, and there can be used an alcohol such as isopropyl alcohol, ethanol or methanol, an ester such as ethyl acetate, a lower hydrocarbon such as pentane or hexane, an aromatic compound such as benzene, toluene or xylene, a ketone, a mixture thereof or the like. There is preferably used a hydrocarbon-based solvent where no oxygen atom is included in the solvent.

Thereafter, magnet powder 42 finely milled by the jet mill 41 is subjected to powder-compaction to form a given shape using a compaction device 50. When wet milling is employed for finely-milling the coarsely-milled magnet powder 31, there can be used dry or wet methods for forming the magnet powder 42 into a shape. The dry method involves filling a cavity with the magnet powder 42 in which the organic solvent is already volatilized and the wet method involves filling a cavity with the slurry including the organic solvent without desiccation. Furthermore, the organic solvent can be volatilized at the sintering stage after formation. In the manufacturing method of permanent magnet 1 according to the present invention, the magnet powder is formed into a desired shape in: (a) an atmosphere composed of noble gas such as argon (Ar) gas, helium (He) gas or the like having an oxygen content of substantially 0%; or (b) an atmosphere composed of noble gas such as Ar gas, He gas or the like having an oxygen content of 0.0001 through 0.5%. As the magnet powder 42 is formed into a shape under an atmosphere of Ar gas, He gas or the like, each being an inert gas, specifically excluding nitrogen gas from inert gases, there can be achieved the residual nitrogen concentration of 800 ppm or lower, or more preferably 300 ppm or lower after sintering, as later described.

As illustrated in FIG. 3, the compaction device 50 has a cylindrical mold 51, a lower punch 52 and an upper punch 53, and a space surrounded therewith forms a cavity 54. The lower punch 52 slides upward/downward with respect to the mold 51, and the upper punch 53 slides upward/downward with respect to the mold 51, in a similar manner.

In the compaction device 50, a pair of magnetic field generating coils 55 and 56 is disposed in the upper and lower positions of the cavity 54 so as to apply magnetic flux to the magnet powder 42 filling the cavity 54. The magnetic field to be applied may be, for instance, 1 MA/m.

When performing the powder compaction, firstly, the cavity 54 is filled with the desiccated magnet powder 42. Thereafter, the lower punch 52 and the upper punch 53 are activated to apply pressure against the magnet powder 42 filling the cavity 54 in a pressure direction of arrow 61, thereby performing compaction thereof. Furthermore, simultaneously with the pressurization, pulsed magnetic field is applied to the magnet powder 42 filling the cavity 54, using the magnetic field generating coils 55 and 56, in a direction of arrow 62 which is parallel with the pressure direction. As a result, the magnetic field is oriented in a desired direction. Incidentally, it is necessary to determine the direction in which the magnetic field is oriented while taking into consideration the magnetic field orientation required for the permanent magnet 1 formed from the magnet powder 42.

Furthermore, if the wet method is used, slurry may be injected while applying the magnetic field to the cavity 54, and in the course of the injection or after termination of the injection, a magnetic field stronger than the initial magnetic field may be applied while performing the wet molding. Furthermore, the magnetic field generating coils 55 and 56 may be disposed such that the application direction of the magnetic field is perpendicular to the pressure direction.

Furthermore, instead of the above-discussed powder compaction, green sheet molding may be employed to produce a formed body. There are several methods, for instance, for producing a formed body by the green sheet molding as shown below. The first method is as follows: mixing milled magnet powder, organic solvent and a binder resin, to obtain slurry, and coating a surface of a base with the slurry at a predetermined thickness using a coating method such as a doctor blade system, die casting or a comma coating system, to form a green sheet. The second method is as follows: mixing the magnet powder and the binder resin to obtain a powdery mixture, and depositing the heated and melted powdery mixture onto a base to form a green sheet. In a case of using the first method for producing the green sheet, magnetic field is applied before the slurry on the base dries, for magnetic field orientation of the green sheet. Meanwhile, in a case of employing the second method for producing the green sheet, the once produced green sheet is heated and magnetic field is applied to the heated green sheet, for magnetic field orientation. Even if the green sheet molding is employed to produce a formed body, the process is still performed under an atmosphere of Ar gas, He gas or the like, each being an inert gas.

Thereafter, the formed body 71 thus produced is held for several hours (for instance, five hours) in a non-oxidizing atmosphere (specifically in this invention, a hydrogen atmosphere or a mixed gas atmosphere of hydrogen and the inert gas) at 200 through 900 degrees Celsius, or more preferably 400 through 900 degrees Celsius (for instance, 600 degrees Celsius), at a pressure equal to or higher than normal atmospheric pressure (for instance, at 0.5 MPa or 1.0 MPa), and a calcination process in hydrogen is performed. The hydrogen feed rate during the calcination is 5 L/min. So-called decarbonization is performed during this calcination process in hydrogen. In the decarbonization, the remaining organic compound is thermally decomposed so that carbon content in the calcined body can be decreased. Furthermore, calcination process in hydrogen is to be performed under a condition that makes carbon content in the calcined body 1500 ppm or lower, or more preferably 1000 ppm or lower. Accordingly, it becomes possible to densely sinter the permanent magnet 1 as a whole in the later sintering process, and the decrease in the residual magnetic flux density or in the coercive force can be prevented.

However, if the green sheet formation is employed for producing a formed body, the formed body is held at a binder-resin decomposition temperature for several hours (for instance, five hours) in a non-oxidizing atmosphere (specifically in this invention, a hydrogen atmosphere or a mixed gas atmosphere of hydrogen and inert gas) at a pressure higher than normal atmospheric pressure (for instance, at 0.5 Mpa or 1.0 MPa) and a calcination process in hydrogen is performed. By the calcination process in hydrogen, the binder resin can be decomposed into monomers through depolymerization reaction, released therefrom and removed. The binder-resin decomposition temperature is determined based on the analysis of the binder decomposition products and decomposition residues. The temperature range to be selected is such that, when the binder resin decomposition products are trapped, no decomposition products except monomers are detected, and when the residues are analyzed, no products due to the side reaction of remnant binder resin components are detected. The temperature differs depending on the type of binder resin, but may be set at 200 through 900 degrees Celsius, or more preferably 400 through 600 degrees Celsius (for instance, 600 degrees Celsius).

Here, NdH₃ exists in the formed body 71 calcined through the calcination process in hydrogen as above described, which indicates a problematic tendency to combine with oxygen. However, in the first manufacturing method, the formed body 71 after the calcination is brought to the later-described sintering without being exposed to the external air, eliminating the need for the dehydrogenation process. The hydrogen contained in the formed body is removed at sintering. A pressure higher than normal atmospheric pressure is optimal as pressurization condition for above-described calcination process in hydrogen; however, 15 MPa or lower is desirable. The normal atmospheric pressure (approx. 0.1 MPa) is also applicable.

Following the above, there is performed a sintering process for sintering the formed body 71 calcined through the calcination process in hydrogen. However, for a sintering method for the formed body 71, there can be employed, besides commonly-used vacuum sintering, pressure sintering in which the formed body 71 is sintered in a pressured state. For instance, when the sintering is performed in the vacuum sintering, the temperature is raised to approximately 800 through 1080 degrees Celsius in a given rate of temperature increase and held for approximately two hours. During this period, the vacuum sintering is performed, and as to the degree of vacuum, the pressure is preferably equal to or lower than 5 Pa, or more preferably equal to or lower than 10⁻² Pa. The formed body 71 is then cooled down, and again undergoes a heat treatment in 300 through 1000 degrees Celsius for two hours. As a result of the sintering, the permanent magnet 1 is manufactured.

Meanwhile, the pressure sintering includes, for instance, hot pressing, hot isostatic pressing (HIP), high pressure synthesis, gas pressure sintering, and spark plasma sintering (SPS) and the like. However, it is preferable to adopt the spark plasma sintering, so as to prevent grain growth of the magnet particles during the sintering and also to prevent a warp from occurring in the sintered magnets. The spark plasma sintering is uniaxial pressure sintering in which pressure is uniaxially applied and also in which sintering is performed by electric current sintering. Incidentally, the following are the preferable conditions when the sintering is performed in the SPS; pressure is applied at 30 MPa, the temperature is raised at a rate of 10 degrees Celsius per minute until reaching 940 degrees Celsius in vacuum atmosphere of several Pa or less and then the state of 940 degrees Celsius in vacuum atmosphere is held for approximately five minutes. The formed body 71 is then cooled down, and again undergoes a heat treatment in 300 through 1000 degrees Celsius for two hours. As a result of the sintering, the permanent magnet 1 is manufactured.

### [Second Method for Manufacturing Permanent Magnet]

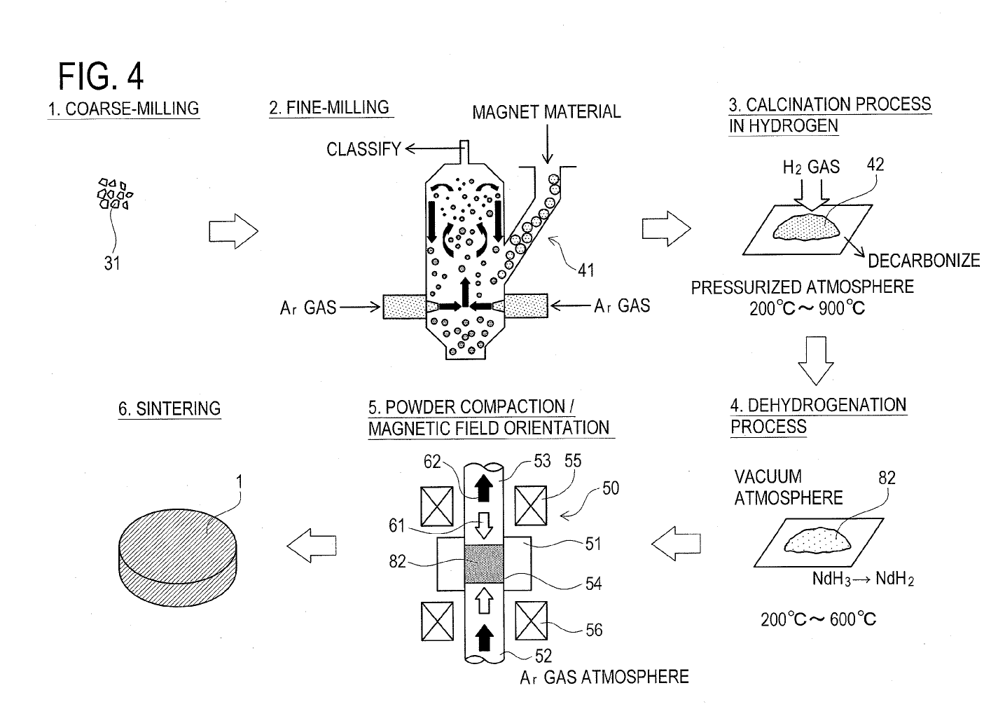

Next, the second method for manufacturing the permanent magnet 1 which is an alternative manufacturing method will be described below with reference to FIG. 4. FIG. 4 is an explanatory view illustrating a manufacturing process in the second method for manufacturing the permanent magnet 1 directed to the present invention.

The process until the magnet powder 42 is manufactured is the same as the manufacturing process in the first manufacturing method already discussed referring to FIG. 3, therefore detailed explanation thereof is omitted.

Firstly, the magnet powder 42 is held for several hours (for instance, five hours) at 200 through 900 degrees Celsius, or more preferably 400 through 900 degrees Celsius (for instance, 600 degrees Celsius) in hydrogen atmosphere at a pressure (for instance, 0.5 MPa or 1.0 MPa) higher than normal atmospheric pressure, for a calcination process in hydrogen. The hydrogen feed rate during the calcination is 5 L/min. Decarbonization is performed in this calcination process in hydrogen. In the decarbonization, the remaining organic compound is thermally decomposed so that carbon content in the calcined powder can be decreased. Furthermore, calcination process in hydrogen is to be performed under a condition that makes carbon content in the calcined powder 1500 ppm or lower, or more preferably 1000 ppm or lower. Accordingly, it becomes possible to densely sinter the permanent magnet 1 as a whole in the later sintering process, and the decrease in the residual magnetic flux density and coercive force can be prevented.

Secondly, the calcined powder 82 in a powdery state calcined through the calcination process in hydrogen is held for one through three hours in vacuum atmosphere at 200 through 600 degrees Celsius, or more preferably 400 through 600 degrees Celsius for a dehydrogenation process. Incidentally, as to the degree of vacuum, the pressure is preferably equal to or lower than 0.1 Torr.

Here, NdH₃ exists in the calcined powder 82 calcined through the calcination process in hydrogen as above described, which indicates a problematic tendency to combine with oxygen.

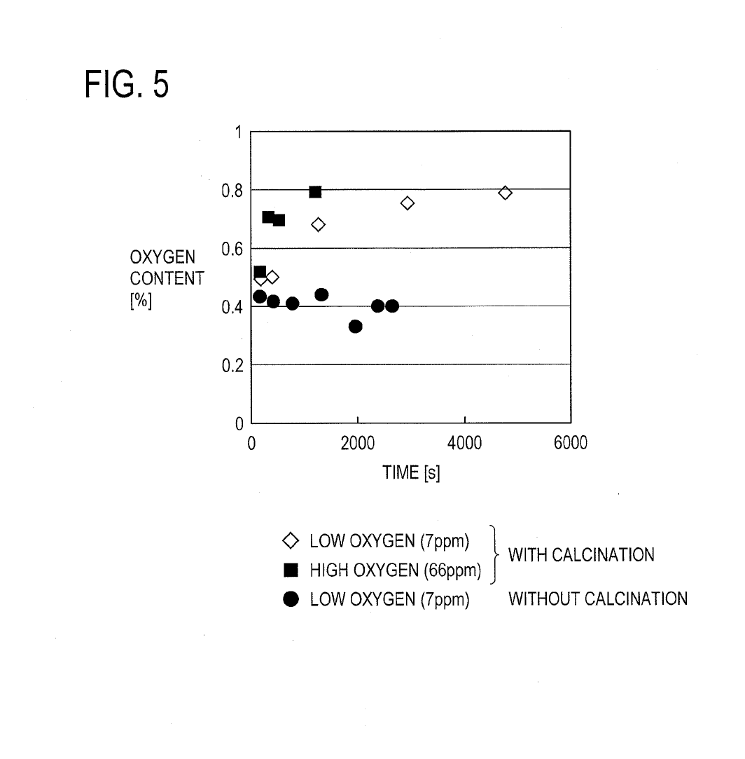

FIG. 5 is a diagram depicting oxygen content of magnet powder with respect to exposure duration, when Nd magnet powder with a calcination process in hydrogen and Nd magnet powder without a calcination process in hydrogen are exposed to each of the atmosphere with oxygen concentration of 7 ppm and the atmosphere with oxygen concentration of 66 ppm. As illustrated in FIG. 5, when the Nd magnet powder with the calcination process in hydrogen is exposed to the atmosphere with high-oxygen concentration of 66 ppm, the oxygen content of the magnet powder increases from 0.4% to 0.8% in approximately 1000 sec. Even when the Nd magnet powder with the calcination process is exposed to the atmosphere with low-oxygen concentration of 7 ppm, the oxygen content of the magnet powder still increases from 0.4% to the similar amount 0.8%, in approximately 5000 sec. Oxygen combined with Nd causes the decrease in the residual magnetic flux density and in the coercive force.

Therefore, in the above dehydrogenation process, NdH₃ (having high reactivity level) in the calcined powder 82 created at the calcination process in hydrogen is gradually changed: from NdH₃ (having high reactivity level) to NdH₂ (having low reactivity level). As a result, the reactivity level is decreased with respect to the calcined powder 82 activated by the calcination process in hydrogen. Accordingly, if the calcined powder 82 calcined at the calcination process in hydrogen is later moved into the external air, Nd is prevented from combining with oxygen, and the decrease in the residual magnetic flux density and coercive force can also be prevented. Then, the calcined powder 82 in a powdery state after the dehydrogenation process undergoes the powder compaction to be compressed into a given shape using the compaction device 50. Details are omitted with respect to the compaction device 50 because the manufacturing process here is similar to that of the first manufacturing method already described referring to FIG. 3.

Then, there is performed a sintering process for sintering the formed-state calcined powder 82. The sintering process is performed by the vacuum sintering or the pressure sintering similar to the above first manufacturing method. Details of the sintering condition are omitted because the manufacturing process here is similar to that of the first manufacturing method already described. As a result of the sintering, the permanent magnet 1 is manufactured.

However, the second manufacturing method discussed above has an advantage that the calcination process in hydrogen is performed to the powdery magnet particles, therefore the thermal decomposition of the remaining organic compound can be more easily caused to the whole magnet particles, in comparison with the first manufacturing method in which the calcination process in hydrogen is performed to the magnet particles of the formed state. That is, it becomes possible to securely decrease the carbon content of the calcined powder, in comparison with the first manufacturing method.

However, in the first manufacturing method, the formed body 71 after calcined in hydrogen is brought to the sintering without being exposed to the external air, eliminating a need for a dehydrogenation process. Accordingly, the manufacturing process can be simplified in comparison with the second manufacturing method. However, also in the second manufacturing method, the dehydrogenation process becomes unnecessary in a case where the sintering is performed without any exposure to the external air after calcined in hydrogen.

### Embodiment

Here will be described an embodiment according to the present invention referring to a comparative example for comparison.

### Embodiment

In comparison with a fraction regarding alloy composition of a neodymium magnet according to the stoichiometric composition (Nd: 26.7 wt %, Fe (electrolytic iron): 72.3 wt %, B: 1.0 wt %), proportion of Nd in that of the neodymium magnet powder for the embodiment is set higher, such as Nd/Fe/B=32.7/65.96/1.34 in wt %, for instance. Further, dry milling has been employed as a milling system, and the milling has been performed under helium atmosphere. A calcination process and a dehydrogenation process have been omitted. The formed body is produced through powder compaction performed under argon atmosphere. Sintering of the formed body has been performed in vacuum atmosphere. Other processes are the same as the processes in [First Method for Manufacturing Permanent Magnet] mentioned above.

### Comparative Example

Milling of magnet material and formation of a formed body are performed under nitrogen atmosphere, respectively. Other conditions are the same as the conditions in the embodiment.

### Comparison of Embodiment with Comparative Example

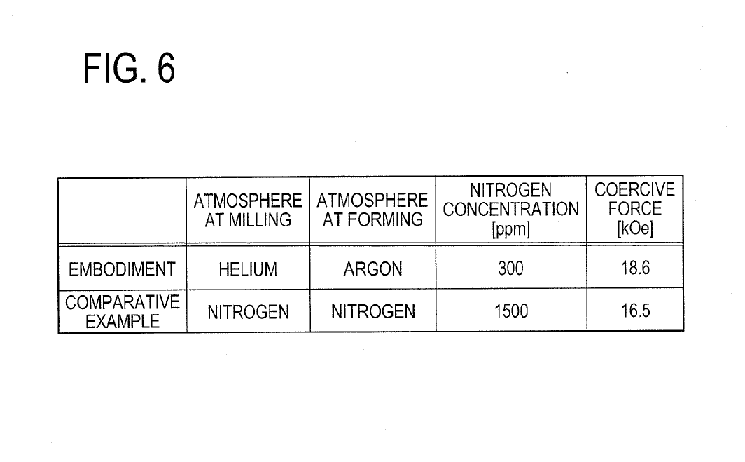

Residual nitrogen concentration [ppm] and coercive force [kOe] in the permanent magnet after sintering are measured in each permanent magnet according to the embodiment and the comparative example. The table of FIG. 6 shows the measurement result.

As shown in FIG. 6, comparison of the embodiment with the comparative example shows that the residual nitrogen concentration in the magnet particles after sintering can be made significantly lower when milling of the magnet material and formation of the formed body are respectively performed under an atmosphere of a noble gas containing no nitrogen therein, than in the case of performing milling of the magnet material and formation of the formed body respectively under nitrogen atmosphere. Specifically, the residual nitrogen concentration in the magnet particles after sintering can be made 800 ppm or lower, or more specifically, 300 ppm or lower in the embodiment. The permanent magnet of the embodiment having lower nitrogen concentration after sintering is capable of improving the coercive force, in comparison with permanent magnet of the comparative example having higher nitrogen concentration.

As a result, through reducing the residual nitrogen concentration after sintering to 800 ppm or lower, or more preferably, 300 ppm or lower, it becomes possible to manufacture the permanent magnet 1 having excellent magnetic performance with improved coercive force.

In the above embodiment and the comparative example, permanent magnets manufactured basically in accordance with [First Method for Manufacturing Permanent Magnet] have been used. Similar results can be obtained in case of using permanent magnets manufactured basically in accordance with [Second Method for Manufacturing Permanent Magnet].

As described in the above, with respect to the permanent magnet 1 and the manufacturing method of the permanent magnet 1 directed to the above embodiment, through dry-milling magnet material under an atmosphere of a noble gas and the milled magnet material is compacted under an atmosphere of a noble gas to produce a formed body. The formed body is then sintered at 800-1180 degrees Celsius to obtain an Nd—Fe—B-based rare-earth permanent magnet having the residual nitrogen concentration of 800 ppm or lower, or preferably, 300 ppm or lower after sintering. Accordingly, the amount of impurities being neodymium nitride (NdN) can be decreased, and the coercive force of the rare-earth permanent magnet can be improved without wasting the Nd-rich phase.

Further, a formed body of magnet powder is calcined in a hydrogen atmosphere at a pressure equal to or higher than normal atmospheric pressure before sintering, so that the amount of carbon contained in magnet particles can be reduced in advance. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Furthermore, the carbon content in the magnet powder can be reduced in advance, as the magnet powder is calcined in hydrogen atmosphere at a pressure equal to or higher than normal atmospheric pressure before sintering. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided.

Further, since powdery magnet particles are calcined, thermal decomposition of the organic compound can be caused more easily in the entirety of the magnet particles in comparison with the case of calcining formed magnet particles. In other words, carbon content in the calcined powder can be reduced more reliably.

Further, the rare-earth permanent magnet 1 is a sintered magnet made from a green sheet obtained by mixing magnet powder and a resin binder and forming the mixture into a sheet-like shape. Therefore, the thus sintered green sheet uniformly contracts and deformations such as warps and depressions do not occur to the sintered green sheet. Further, the sintered green sheet having uniformly contracted receives pressure uniformly, which eliminates adjustment process to be conventionally performed after sintering and simplifies the manufacturing process. Thereby, a rare-earth permanent magnet 1 can be manufactured with dimensional accuracy. Further, even if such rare-earth permanent magnets 1 are manufactured with thinner design, increase in the number of manufacturing processes can be avoided without lowering a material yield. Further, magnet powder to which a binder resin has been added is calcined for a predetermined length of time under a non-oxidizing atmosphere before sintering, whereby carbon content in the permanent magnet can be reduced previously. Consequently, previous reduction of carbon can prevent alpha iron from separating out in a main phase of the sintered magnet and the entirety of the magnet can be sintered densely. Thereby, decrease in the coercive force can be prevented.

Further, in the step of decomposing and removing the binder resin, the magnet particles are held for a predetermined length of time in a pressurized atmosphere at a pressure equal to or higher than normal atmospheric pressure. Thereby, the remaining organic compound thermally decomposes before sintering so that carbon contained in the magnet particles can be removed (carbon content can be reduced) in advance, and almost no carbide is created during the sintering process. Consequently, the entirety of the magnet can be sintered densely without making a gap between a main phase and a grain boundary phase in the sintered magnet, and decline of coercive force can be avoided. Further, considerable amount of alpha iron does not separate out in the main phase of the sintered magnet and serious deterioration of magnetic properties can be avoided. It is to be understood that the present invention is not limited to the embodiment described above, but may be variously improved and modified without departing from the scope of the present invention.

Further, of magnet powder, milling condition, mixing condition, calcination condition, dehydrogenation condition, sintering condition, etc. are not restricted to conditions described in the embodiment. For instance, calcination process or dehydrogenation process may be omitted. In the above embodiment, the calcination process is performed under a hydrogen atmosphere pressurized to 0.5 MPa, for instance; however, the pressure can be set at a different value as long as it is higher than normal atmospheric pressure. Further, the pressure value can be set at normal atmospheric pressure. However, a pressure higher than the normal atmospheric pressure can facilitate the decarbonization effect by the calcination process. Further, the vacuum sintering is employed in the embodiment; however, pressure sintering such as SPS method may be employed.

Description of the present invention has been given by taking the example of the Nd—Fe—B-based magnet. However, magnet made of other kinds of material may be used. Further, in the embodiment of present invention, the proportion of Nd component ratio with reference to the alloy composition of the magnet is set higher in comparison with Nd component ratio in accordance with the stoichiometric composition. The proportion of Nd component may be set the same as the alloy composition according to the stoichiometric composition.

### EXPLANATION OF REFERENCES

1 permanent magnet
11 main phase
12 Nd-rich phase
42 magnet powder
71 formed body
82 calcined powder

1. A rare-earth permanent magnet based on Nd—Fe—B, wherein a residual nitrogen concentration after sintering is 800 ppm or lower.

2. The rare-earth permanent magnet according to claim 1, manufactured through steps of:
milling magnet material in an atmosphere of a noble gas to obtain magnet powder;
forming the magnet powder into a formed body in an atmosphere of a noble gas; and
sintering the formed body.

3. The rare-earth permanent magnet according to claim 2, wherein, before the step of sintering the formed body, the formed body is calcined in a hydrogen atmosphere at a pressure equal to or higher than normal atmospheric pressure.

4. The rare-earth permanent magnet according to claim 2, wherein, before the step of forming the magnet powder into a formed body, the magnet powder is calcined in a hydrogen atmosphere at a pressure equal to or higher than normal atmospheric pressure.

5. The rare-earth permanent magnet according to claim 2, wherein:
in the step of forming the magnet powder into a formed body, the magnet powder is mixed with a binder resin to produce a mixture and the mixture is formed into a sheet like shape to obtain a green sheet as the formed body;
the steps of manufacturing further include a step of decomposing and removing the binder resin from the green sheet by holding the green sheet for a predetermined length of time at decomposition temperature of the binder resin in a non-oxidizing atmosphere; and
in the step of sintering the formed body, the green sheet after removing the binder resin is sintered through raising temperature up to sintering temperature.

6. The rare-earth permanent magnet according to claim 5, wherein, in the step of decomposing and removing the binder resin, the green sheet is held for a predetermined length of time in the non-oxidizing atmosphere at a pressure equal to or higher than normal atmospheric pressure.

7. A manufacturing method of a rare-earth permanent magnet based on Nd—Fe—B, comprising steps of:
milling magnet material in an atmosphere of a noble gas to obtain magnet powder;
forming the magnet powder into a formed body in an atmosphere of a noble gas; and
sintering the formed body.

8. The manufacturing method of a rare-earth permanent magnet according to claim 7, wherein, before the step of sintering the formed body, the formed body is calcined in a hydrogen atmosphere at a pressure equal to or higher than normal atmospheric pressure.

9. The manufacturing method of a rare-earth permanent magnet according to claim 7, wherein, before the step of forming the magnet powder into a formed body, the magnet powder is calcined in a hydrogen atmosphere at a pressure equal to or higher than normal atmospheric pressure.

10. The manufacturing method of a rare-earth permanent magnet according to claim 7, wherein:
in the step of forming the magnet powder into a formed body, the magnet powder is mixed with a binder resin to produce a mixture and the mixture is formed into a sheet like shape to obtain a green sheet as the formed body;
the steps of the manufacturing method further include a step of decomposing and removing the binder resin from the green sheet by holding the green sheet for a predetermined length of time at decomposition temperature of the binder resin in a non-oxidizing atmosphere; and
in the step of sintering the formed body, the green sheet after removing the binder resin is sintered through raising temperature up to sintering temperature.

11. The manufacturing method of a rare-earth permanent magnet according to claim 10, wherein, in the step of decomposing and removing the binder resin, the green sheet is held for a predetermined length of time in the non-oxidizing atmosphere at a pressure equal to or higher than normal atmospheric pressure.
